(19) United States
(12) Patent Application Publication
(10) Pub. No.: US 2014/0297651 A1
(43) Pub. Date: Oct. 2, 2014

(54) USING HASH TABLE TO RETRIEVE LEAF INDEX BLOCKS

(71) Applicant: Moshe SHADMON, Palo Alto, CA (US)

(72) Inventor: Moshe SHADMON, Palo Alto, CA (US)

(73) Assignee: ORI SOFTWARE DEVELOPMENT LTD., Tel-Aviv (IL)

(21) Appl. No.: 14/199,095

(22) Filed: Mar. 6, 2014

Related U.S. Application Data
(60) Provisional application No. 61/807,088, filed on Apr. 1, 2013.

(51) Int. Cl. G06F 17/30

(52) U.S. Cl. CPC G06F 17/30321
USPC 707/741

(57) ABSTRACT

In a Database Management System (DBMS), an index is used to organize the data such that the data can be efficiently retrieved to satisfy queries. The index may be organized in blocks which are stored in memory or on disk of a computer system. To satisfy a DBMS request, such as an update or query of data, multiple index blocks may need to be retrieved and processed. The claimed subject matter reduces the number of index blocks that needs to be retrieved and processed to satisfy the DBMS requests.

This nonprovisional application claims the benefit of U.S. Provisional Application No. 61/807,088, filed Apr. 1, 2013.

### FIELD OF THE INVENTION

The present invention is in the general field of indexing searching and updating of data.

### BACKGROUND OF THE INVENTION

A discussion on indexing can be found in The Art of Computer Programming, volume 3/Sorting and Searching, by Donald Knuth (©1973, Addison-Wesley). More specifically, a discussion on B-trees can be found on pages 473-479, a trie is discussed on pages 481-490, and a discussion on Patricia structure can be found on pages 490-499.

Additional information on a Trie structure is detailed in File Organization for Database Design, by Gio Wiederhold, Mcgraw-Hill, Pages 272-273.

A Patricia structure is an index structure derived from a trie such that only nodes that have at least two children are maintained. Since the nodes with one child are compressed, the nodes in a Patricia include the key position differentiated by the node. Because of that compression, the size of the Patricia structure might be less than the aggregate size of the keys addressed by the Patricia. A balanced Patricia Trie index is described in U.S. Pat. No. 6,175,835 and the description and methods of the balanced Patricia Trie are incorporated here by this reference.

A Hash table is a structure that can be used as an index in a database. It is useful for exact match queries. It is not useful for range queries. Hash tables generally require one block read to access a single record. A more complete description of hash tables can be found on e.g. pages 473-479 of The Art of Computer Programming, volume 3, by Donald Knuth (© 1973, Addison-Wesley).

### GLOSSARY OF TERMS

Data—Information that one wants to store and/or manipulate.

Database—A collection of data organized by some set of rules.

Attribute—A feature or characteristic of specific data, represented e.g, as “columns” in a relational database. A record representing a person might have an attribute “age” that stores the person's age.

Column—In a relational database, columns represent attributes for particular rows in a relation. For example, a single row might contain a complete mailing address. The mailing address would have four columns (“attributes”): street address, city, state, and zip code.

Record—A single entry in a database. Often referred to as a “tuple” or “row” in a relational database.

Tuple—See “record”

Row—See “record”

Row ID—An identification of the row used to locate the row in the database. Examples of Row IDs are: an offset of the row in the file, a number that can be used to determine the location of the row in the file, a key value which is provided to a process that returns the row. In the context of the invention, the Row ID is an identifier that is provided to a process which is not part of the invention, said process returns a row which is uniquely identified by the id.

Block ID—a unique identifier of a block such that if provided to the process that returns the block, the block can be located and returned to the process requesting the block.

Table—See “relation”

Relation—A way of organizing data into a table consisting of logical rows and columns. Each row represents a complete entry in the table. Each column represents an attribute of the row entries. Frequently referred to as a “table.”

Relational database—A database that consists of one or more “relations” or “tables”

Schema—The organization of data in a database. In a relational database, all new data that comes into the database must be consistent with the schema, or the database administrator must change the schema (or reject the new data).

Index—Extra information about a database used to reduce the time required to find specific data in the database. It provides access to particular rows based on a particular column or columns. A column or columns that provide the access to particular rows are considered as a Key.

Path—A series of object of the database that are processed to satisfy a request in the database. For example, the database includes an index partitioned to blocks, updating the index or searching using the index requires retrieving and processing one or more such blocks. The Path is the sequence of said blocks.

Query—A search for information in a database.

Range query—A search for a range of data values, like “all employees aged 25 to 40.”

Point lookup—A search for particular data, like “employee with SSN 672-55-4315”.

I/O—A read from a physical device, such a fixed disk (hard drive). I/Os take a significant amount of time compared to memory operations: usually hundreds and even thousands of times (or more) longer.

Block read—Reading a fixed sized chunk of information for processing. A block read implies an “I/O” if the block is not in memory.

Tree—A data structure that is either empty or consists of a root node linked by means of d (d≧0) pointers (or links) to d disjoint trees called subtrees of the root. The roots of the subtrees are referred to as “child nodes” of the root node of the tree, and nodes of the subtrees are “descendent nodes” of the root. A node in which all the subtrees are empty is called a “leaf node.” The nodes in the tree that are not leaves are designated as “internal nodes.”

In the context of the invention, leaf nodes are also nodes that are associated with data. Nodes and trees should be construed in a broad sense. Thus, the definition of tree encompasses also a tree of blocks wherein each node constitutes a block. In the same manner, descendent blocks of a said block are all the blocks that can be accessed from the block. For detailed definition of “tree,” also refer to the book by Lewis and Deneberg, “Data structures and their algorithms.”

B-tree—A tree structure that can be used as an index in a database. It is useful for exact match and range queries. B-trees frequently require multiple block reads to access a single record. A more complete description of B-trees can be found on pages 473-479 of The Art of Computer Programming, volume 3, by Donald Knuth (© 1973, Addison-Wesley).

Hash table—A structure that can be used as an index in a database. It is useful for exact match queries. It is not useful for range queries. Hash tables generally require one block read to access a single record. A more complete description of hash tables can be found on e.g. pages 473-479 of The Art of Computer Programming, volume 3, by Donald Knuth (© 1973, Addison-Wesley).

Key—An identifier used to refer to particular rows in a database. In the context of relational database, keys represent column information used to identify rows. For instance, “social security number” could be a key that uniquely identifies each individual in a database. Keys may or may not be unique.

Join—A method of matching portions of two or more tables to form a (potentially much larger) unified table. This is generally one of the most expensive relational database operations, in terms of space and execution time.

Key search—The search for a particular value or data according to a key value. This search is usually performed by an index.

Search—In the context of data, searching is the process of locating relevant or desired data from a (typically much larger) set of data based on the content and/or structure of the data. Searching is often done when a request is submitted to the system, and after processing the request, the system returns the data or references to the data that match the request. Typical (yet not exclusive) examples of searching are the submission of a query to a relational database system, or the submission of key words to a search engine on the World Wide Web.

Access—In the context of data, access is the process of obtaining data, typically through searching, browsing, or through following references.

Sibling—Elements of a tree that share the same parent are siblings. This is the same sense as brothers and sisters are siblings.

Complete-key indexing—An indexing method that stores the key as part of the index. This provides an exact “hit or miss” result when using the index, but is very large when the keys are large. This is contrasted with a “compressed-key indexing.”

Compressed-key indexing—A compressed-key index does not store the entire key in the index, thus can be significantly smaller than a complete-key index (for the same keys). However, it may provide “false positives” (that can be removed later). It should not miss relevant records (“false negatives”). This is contrasted with a “complete-key indexing.” A Compressed-key indexing is described e.g. in U.S. Pat. No. 6,175,835.

### SUMMARY OF THE INVENTION

In a Database Management System (DBMS), an index is used to organize the data such that the data can be efficiently retrieved to satisfy queries. The index may be organized in blocks which are stored in memory or on disk of a computer system. To satisfy a DBMS request, such as an update or query of data, multiple index blocks may need to be retrieved and processed. This invention reduces the number of index blocks that needs to be retrieved and processed to satisfy the DBMS requests. In a DBMS, data may be organized in rows; the rows may be organized in blocks and stored on disk of a computer system. Users may interact with the DBMS to update or retrieve the data. One of the methods to specify a request to a DBMS is by issuing a statement in Standard Query Language (SQL). For example, a user may issue SQL requests to the DBMS to add a row using Insert statement, to update the content of the row using an Update statement, to delete a row using a Delete statement and to select one or more rows using a Select statement.

To efficiently process the request, the database may contain indexes. An index is a data structure that allows locating a row by its key value. Some indexes are built to manage the order between the keys and some not. An index that supports the order would satisfy a request to get the next (and sometimes the previous) key value. The Btree index structure and the Trie index structure manage the order between the keys.

The invention provides a storage medium used by a database file management system executed on data processing system, a data structure comprising: an index, partitioned into blocks, leaf blocks of said index include pointers to data records, non-leaf blocks of said index include pointers to other blocks such that the index structure allows locating data by a key value. Given a key K, the process starts from reading a particular block (sometimes referenced as and hereon, the Root Block) and continues by reading a sequence of 0 or more additional blocks to find the leaf block (or blocks) that includes a pointer (or pointers) to the data record (or multiple data records) whose key is K. Said leaf block is considered as a block that address the data. Said invention further provides a Hash table. The Hash table of the invention provides mapping between a key value and a block in the index such that said block is on the path from the root block to the leaf block (or blocks), whereas said leaf block (or blocks) include a pointer (or pointers) to the data record (or multiple data records) whose key is K. In the case of an Insert and delete operations, the Hash table is used to locate the block of the index that needs to be updated or a block on the path to the block that needs to be updated. In the case of Update or Select, the Hash table is used to locate the leaf block of the index that needs to be processed to locate the row or rows whose key is K or a block on the path to the leaf blocks of the index that include pointers to the rows whose key is K.

In the context of the invention, a pointer may be any representation that allows locating a particular object such as a block or a row. A block with one or more pointers to rows is considered a block that addresses data. An example of a pointer would be an offset in a file or a key value that is provided to a process that returns the object by the given key.

In the context of the invention, a path is a sequence of blocks of the index that are retrieved and processed in order to locate the requested row or rows or the sequence of blocks of the index that are retrieved processed and updated in order to represent a new key in the index or remove a representation of a key from the index.

The invention reduces the number of blocks that are retrieved and processed by efficiently locating a block on the path and starting the processing for said block rather than from the Root Block of the index.

### BRIEF DESCRIPTION OF THE DRAWINGS

FIG. 1 demonstrates an index based on a trie structure. Said index can be organized in a block.

FIG. 2 demonstrates the result of multiple splits of index blocks whereas the first split is the split of the block of FIG. 1.

### DETAILED DESCRIPTION OF THE INVENTION

As it was explained in the US Patent Publication US20020120598 A1 published Aug. 29, 2002 and entitled “Encoding Semi-Structured Data For Efficient Search and Browse” (herein the Semi-Structured Publication), whose contents in its entirety is incorporated herein by reference. The first paragraph of the summary of the Semi-Structured Publication (Col. 5 [0087]) defines efficiency as:

“efficient access means the ability to locate relevant data in a short amount of time or with only a small number (e.g., several) disk accesses, even though the data items stored may number in the millions or more, or even though the total size of the data items is such that they cannot all fit in the memory available to the search process. Efficient access refers to the overall or typical behavior of the system. In other words, while individual accesses may sometimes be inefficient, the access behavior observed over time is efficient.”

It is farther noted that the US20020120598 demonstrated an index based on a Patricia Trie which is partitioned into blocks. Said index supports both Range Queries and Point Lookups.

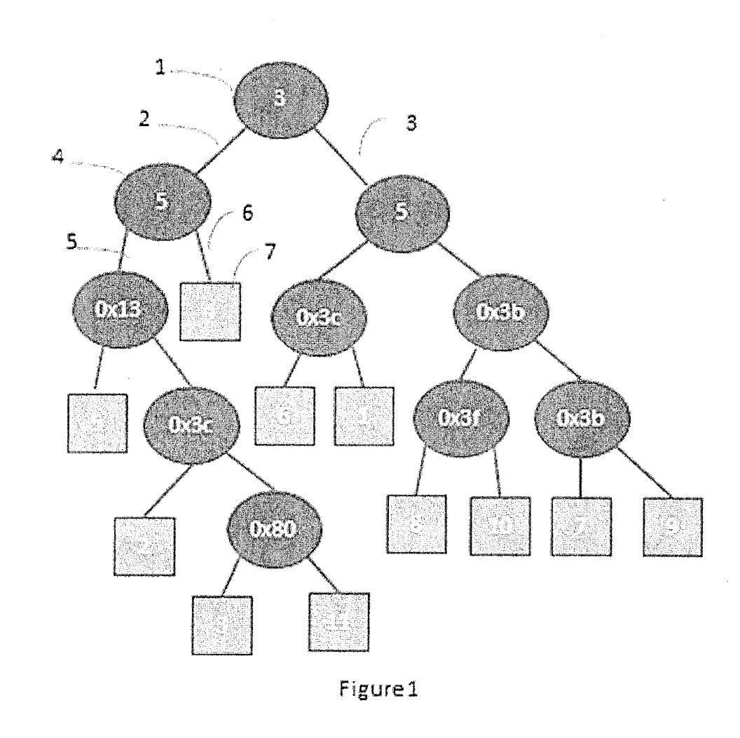

FIG. 1 is and index over data rows. The rows represent customer's information stored in the database. The said index is based on a Patricia Trie and the key field is the customer name. The chart below shows part of the information of the rows being indexed (SSN and the customer name), and the key values (the names) in string and hexadecimal representation.

Note, ‘A’ is 0x41, ‘B’ is 0x42, etc. ‘a’ is 0x61, ‘b’ is 0x62 etc. Space is 0x20.

The key field in the index of FIG. 1 is the customer name. This key is non-unique therefore; multiple customers with the same name may be represented in the index.

The Row ID in the chart below can be considered as locator of the data. The Row Id 1 addresses the customer Smith John, the Row ID 2 address the customer Jordan David etc. The Row ID can determine the location of the row in multiple ways. For example, assuming the customers rows are of fixed size, the Row ID can be multiplied by the length of the row to determine the location of the row within a file.

| | | Key value | |
|---|---|---|---|
| Row ID | SSN | (string) | Key value (hexadecimal) |
| 1 | 723-78-7782 | Smith John | 53, 6d, 69, 74, 68, 20, 4a, 6f, |
| | | | 68, 6e |
| 2 | 892-98-7789 | Jordan David | 4a, 6f, 72, 64, 61, 6e, 20, 44, |
| | | | 61, 76, 69, 64 |
| 3 | 771-33-4490 | Jordan Michael | 4a, 6f, 72, 64, 61, 6e, 20, 4d, |
| | | | 69, 63, 68, 61, 65, 6c |
| 4 | 233-22-4545 | Murphy Kevin | 4d, 75, 72, 70, 57, 79, 20, 4b, |
| | | | 65, 76, 69, 6e |
| 5 | 229-88-2256 | Johnson Lisa | 4a, 6f, 68, 6e, 73, 6f, 6e, 20, |
| | | | 4c, 69, 73, 61 |
| 6 | 919-89-7722 | Smith James | 53, 6d, 69, 74, 68, 20, 4a, 61, |
| | | | 6d, 65, 73 |
| 7 | 626-123-998 | Topper Rachel | 54, 6f, 70, 70, 6e, 72, 20, 52, |
| | | | 61, 63, 65, 6c |
| 8 | 878-22-4874 | Topper Ori | 54, 6f, 70, 70, 6e, 72, 20, 4f, 72, |
| | | | 69 |
| 9 | 565-36-9356 | Topper Roy | 54, 6f, 70, 70, 6e, 72, 20, 52, 6f, |
| | | | 79 |
| 10 | 873-67-6373 | Topper Noa | 54, 6f, 70, 70, 6e, 72, 20, 4e, 4f, |
| | | | 41 |
| 11 | 367-44-8843 | Jordan Michael | 4a, 6f, 72, 64, 61, 6e, 20, 44, |
| | | | 61, 76, 69, 64 |

Since the index of the example is using a Patricia Trie, nodes in the index represent the differences between keys. FIG. 1 shows the index structure over the rows in the chart above. Since all the keys start with a character between 0x4a and 0x54, the first node in the index (marked 1) would have the value 3 which is the bit position differentiating between 4 (binary 0100) and 5 (binary 0101) assuming the first bit is at position 0. FIG. 1 shows the root node with the value 3 and a left link (marked 2) to all the rows that have the value 4 at the high four bits of their first byte value and a right link (marked 3) to all the rows that have the value 5 at the high four bits of their first byte value. The node marked 4 differentiates between the keys prefixed with the bits 0100 1010 (0x4a) and 0100 1101 (0x4f) therefore the node marked 4 would have the value 5. The value 5 represents the fact that all the rows which are addressed by the sub-tree whose root is the node marked 4 share the same 5 bit prefix whereas the rows in the left sub-tree are with 0 value at bit 5 whereas the rows at the right sub-tree are with the value 1 at bit 5. The link marked 5 therefore address all the rows whose key is prefixed by the character ‘J’ and the link marked 6 address the row whose key is prefixed by the character ‘M’—the row with ID 4 representing the customer “Murphy Kevin”. This customer is represented in FIG. 1 as a box with the customer's Row ID (marked 7).

A search for a row by the index would consider the bit values of the key being searched at the position represented by the nodes and would follow a left link if the bit value is 0 and a right link if the bit value is 1. For example, the search for the row whose key is “Murphy Kevin” starts at the root node (marked 1) and considers bit 3 of the key with the value 0, therefore the left link (marked 2) would lead the search to the node representing bit 5 (marked 4). Thereafter bit 5 of the key is considered and as the bit value is 1, the right link (marked 6) directs the search to the row whose ID is 4 (marked 7) to find the requested row.

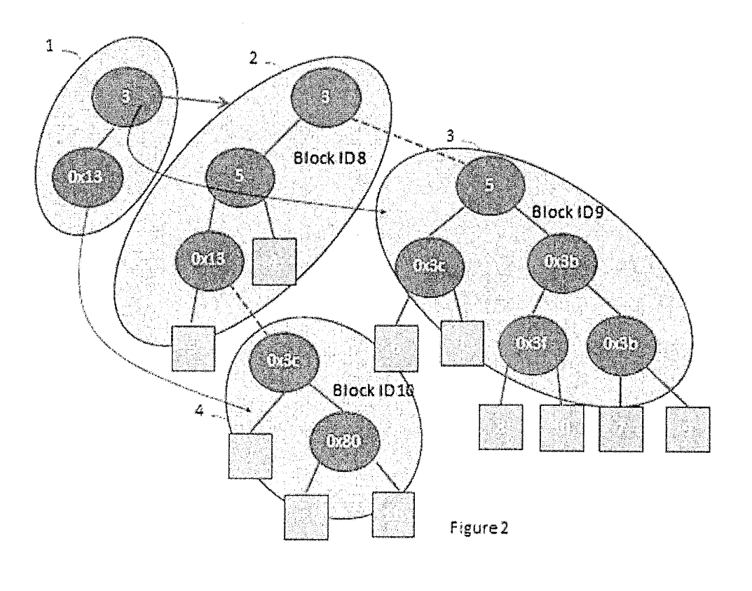

The index of FIG. 1 is contained in a single block. If more keys are being indexed, the index grows and at some point cannot be contained in a single block. Therefore the block splits. The index of FIG. 2 exemplifies an index structure partitioned into several blocks that were formed during split processes of the said index. The index of FIG. 1 is contained in the leaf blocks marked 2, 3 and 4 of FIG. 2. The dashed lines between the block are the links that were disconnected to allow the split and the index in block 1 is the root block that locates the leaf block by the key values. The index of FIG. 2 is of 2 layers of blocks—the leaf layer containing the blocks that address the data (considered as layer 1) and the root block (considered as layer 2). The search in this index starts from the root block (marked 1) and continues to the leaf block. If more rows are added, the blocks of the leaf layer would split and update the root block. At some point, the root block will grow such that it will not be contained in a single block and would split creating a new layer (layer 3) that would index the blocks of layer 2. With 3 layers, a search by a key starts at the root block of layer 3 and continues to a block at layer 2 that directs the search to the block at layer 1 that address the data. As seen, multiple blocks are needed to be retrieved to provide the search or allow an insert of new data (as a leaf block needs to be updated to address the new inserted key). These blocks may be stored on disk such that the retrieval process requires IO operations. When the blocks are in memory, they need to be processed to determine the search path. These processes require CPU time and may trigger other operations that would use different resources of the computer system and the database. Large databases maintain large index files therefore the path in the index to satisfy a query or support an index may involve retrieval of many blocks. These processes were described in detail in U.S. Pat. No. 6,175,835.

In order to minimize IO and resource usage in index processes, a hash table is used to locate the leaf block of the index that needs to be processed. By locating the leaf block, the IO operations and the additional processes and resource usage of the non-leaf blocks are eliminated.

A hash table is a data structure that is often used in a database to locate objects in the database by a key value. In a hash table, a hash formula translates a key value to a number within a given range. Given a key, the hash number is calculated by the hash formula and is used to locate the needed object. Different hash formulas are available. Hash formulas will try to minimize the cases where different keys generate the same numbers. Ideally, when a hash number is provided, 0 or 1 candidates are available. Hash formulas sometimes provide false positive candidates.

The following description demonstrates the characteristics of the invention by using a simplistic hash formula (as the hash formula itself is not part of this invention). The example below demonstrates the mapping of the name keys to numbers between 1 and 255 using the following method—creating an 8 bits number such that the 4 high bits of the number are the 4 low bits of the first byte of the last name and the low 4 bits of the number are taken from the 4 low bits of the byte of the first name. The generated values are offsets in a table that maintains the Row IDs of the data records. The table below shows the hash values generated from the keys:

| Row | Key | | Hash |
|---|---|---|---|
| ID | value (string) | Key value (hexadecimal) | Value |
| 1 | Smith John | 53, 6d, 69, 74, 68, 20, 4a, 6f, 68, 6e | 0x3a |
| 2 | Jordan David | 4a, 6f, 72, 64, 61, 6e, 20, 44, 61, 76, 69, 64 | 0xa4 |
| 3 | Jordan | 4a, 6f, 72, 64, 61, 6e, 20, 4d, 69, 63, 68, 61, | 0xad |
| | Michael | 65, 6c | |
| 4 | Murphy | 4d, 75, 72, 70, 57, 79, 20, 4b, 65, 76, 69, 6e | 0xdb |
| | Kevin | | |
| 5 | Johnson Lisa | 4a, 6f, 68, 6e, 73, 6f, 6e, 20, 4c, 69, 73, 61 | 0xac |
| 6 | Smith James | 53, 6d, 69, 74, 68, 20, 4a, 61, 6d, 65, 73 | 0x3a |
| 7 | Topper | 54, 6f, 70, 70, 6e, 72, 20, 52, 61, 63, 65, 6c | 0x42 |
| | Rachel | | |
| 8 | Topper Ori | 54, 6f, 70, 70, 6e, 72, 20, 4f, 72, 69 | x4f |
| 9 | Topper Roy | 54, 6f, 70, 70, 6e, 72, 20, 52, 6f, 79 | 0x42 |
| 10 | Topper Noa | 54, 6f, 70, 70, 6e, 72, 20, 4e, 4f, 41 | 0x4e |
| 11 | Jordan | 4a, 6f, 72, 64, 61, 6e, 20, 44, 61, 76, 69, 64 | 0xa4 |
| | Michael | | |

The hash table below stores the row ID at the offset provided by the hash value:

| Table Offset | Row ID |
|---|---|
| 0x3a | 1, 6 |
| 0x42 | 7, 9 |
| 0x4e | 10 |
| 0x4f | 8 |
| 0xa4 | 2, 11 |
| 0xac | 5 |
| 0xad | 3 |
| 0xdb | 4 |

A search for a particular row by its key using the hash table would calculate the hash value using the hash formula and use the value as an offset in a table to retrieve the Row ID. In the case where multiple keys are hashed to the same value, multiple rows are retrieved and are evaluated to determine the rows that satisfy the request.

The invention is using a dynamic hash table. When the database is using an index to insert, update, delete or retrieve rows, the hash table is updated such that the entry in the hash maintains an id of the leaf block of the index that includes a pointer to the row. The hash table does not need to represent all the rows in the database. Only the last frequently used are represented and in a particular embodiment, as multiple keys may generate the same hash value, if a row generate a value which is being used, the older is removed from the hash table and only the latest is used.

The chart below shows table offsets determined by the hash value and the ID of the leaf block of the Patricia Trie index that address the row that hash to this value. The IDs of the blocks are shown in FIG. 2.

| Table Offset | Block ID |
|---|---|
| 0x3a | 9 |
| 0x42 | 9 |
| 0x4e | 9 |
| 0x4f | 9 |
| 0xa4 | 10 |
| 0xac | 8 |
| 0xad | 10 |
| 0xdb | 8 |

With the hash table above, the database can process the index more efficiently as in some database operations as exemplified below, the index process starts from the leaf block rather than the root. In the case where a particular key generates a hash value which has null entry in the hash table or in the case that the process using the hash table fails (as will be demonstrated below), the data would be retrieved using the index by traversal from the root block of the index to the leaf block of the index.

Insert of new data—if the key values are non-unique, and the hash table includes an entry representing the said non-unique key, the ID of the leaf block of the index is provided by the hash table and the block is retrieved to insert the new key. With unique keys, the hash of predetermined bits from the prefix of the key would be able, in some cases, to determine the leaf block of the index that needs to be updated. For example, if the indexed key is an 8 bytes number, hash table over the first 7 bytes may determine the ID of the leaf block of the index.

Delete of data—if the hash table includes an entry for the key value that is deleted, the ID of the leaf block of the index is provided by the hash table and the block is retrieved to delete the new key.

Range query—the range query can use the key that defines the boundary of the range to find, using the hash table, the leaf block which address the said key and continue the traversal from the said block to retrieve additional keys that are needed to satisfy the query.

The method of creating a hash table over index blocks can yield false positives as an index block splits and a key that was addressed by a particular block may be addressed by a different block after the split. For example, FIG. 1 shows rows addressed by a single block whereas after the split and as demonstrated in FIG. 2, the same rows are addressed by multiple and different index blocks. Therefore when a leaf block is retrieved using the hash table, it may be determined that a wrong block was retrieved and the process over the index would restart from the root block ignoring the hash. False positives may also be the result of different keys that hash to the same value and in the same manner, the failure will trigger a new process using the index and ignoring the hash table.

With a Patricia Trie, identifying that the wrong block is offered by the hash table is done by comparing the bits of the key used to locate the block with the bits of one of the keys of the rows addressed by the block. If the first position of difference is at an offset which is less that the offset represented by the root node of the block, the wrong block was provided by the hash table and a new search process without the usage of the hash table is initiated. For example, Michael Jordan is addressed by the block with the ID 10 (marked 4). If the row of Michael Jordan is retrieved using the name index, the dynamic hash table is updated such that the entry at the offset calculated by the hash formula in the hash table is updated to address the block whose ID is 10. Thereafter, block 10 is split and the sub-tree that includes the pointer to the row representing Michael Jordan is moved to a new block. As the hash table may not be updated accordingly, a process using the hash table may continue to determine, after the split, that Michael Jordan is addressed by the block with the ID 10. If the said wrong block is used in the retrieval process, it can further be determined that the wrong block is provided and the process of using the hash table is replaced by a process that uses the index and a path from the root block to the leaf block is initiated.

For a Btree index, the range of keys in the block may determine if the block provided is the needed block.

1. In a database management system; an index over data rows; said index is partitioned into blocks; said blocks include leaf blocks that address the data and non-leaf blocks that allow to locate the needed one or more leaf blocks. A process using the index; said process adds a new key; said process starts from the leaf block of the index.

2. In a database management system; an index over data rows; said index is partitioned into blocks; said blocks include leaf blocks that address the data and non-leaf blocks that allow to locate the needed one or more leaf blocks. A process using the index; said process deletes an existing key; said process starts from the leaf block of the index.

3. In a database management system; an index over data rows; said index is partitioned into blocks; said blocks include leaf blocks that address the data and non-leaf blocks that allow to locate the needed one or more leaf blocks. A process using the index; said process is a range scan; said process starts from the leaf block of the index.

4. The method of claim 1 whereas the leaf block of the index is located by a hash table.

5. The method of claim 2 whereas the leaf block of the index is located by a hash table.

6. The method of claim 3 whereas the leaf block of the index is located by a hash table.

7. In a database management system; an index over data rows; said index is partitioned into blocks; said blocks include leaf blocks that address the data and non-leaf blocks that allow to locate the needed one or more leaf blocks. A process using the index started from the leaf block, said process determined that the wrong leaf block was provided, said process restarted using the index from the root block.

8. In a Database Management System (DBMS), an index is used to organize the data such that the data can be efficiently retrieved to satisfy queries. Said index may be organized in blocks which are stored in memory or on disk of a computer system. Said DBMS satisfies queries by a process that includes retrieving multiple index blocks to find the leaf block that maintains the pointers to the desired data. Said process is considered as second step; said processing includes a first step that retrieves a leaf block; said first step determines if the said leaf block is not false positive and ignores the second step.

9. In a Database Management System (DBMS), an index is used to organize the data such that the data can be efficiently added to the database. Said index may be organized in blocks which are stored in memory or on disk of a computer system. Said DBMS satisfies inserts by a process that includes retrieving multiple index blocks to find the leaf block that needs to be updated. Said process is considered as second step; said processing includes a first step that retrieves a leaf block; said first step determines if the said leaf block is not false positive and ignores the second step.
